(19) United States
(12) Patent Application Publication
(10) Pub. No.: US 2020/0009903 A1
(43) Pub. Date: Jan. 9, 2020

(54) ERASABLE WATERMEDIA SURFACE SYSTEM AND METHOD OF USE

(71) Applicants: Allen Miller, Delray Beach, FL (US); Irving Engel, Lake Forest, CA (US)

(72) Inventors: Allen Miller, Delray Beach, FL (US); Irving Engel, Lake Forest, CA (US)

(21) Appl. No.: 16/019,628

(22) Filed: Jun. 27, 2018

(51) Int. Cl. B44D 3/18

(52) U.S. Cl. CPC B44D 3/18

(57) ABSTRACT

Embodiments are described for an erasable watermedia surface assembly and method of use which enables tube-type and pan-type watercolor paint and pigment to be selectively applied and erased both before and after drying. The watermedia surface assembly consists of a tempered hardboard with laminates of water based contact cement and watercolor paper treated with several layers of matte urethane or polycrylic topcoat finish which provides a light-weight assembly for many traditional and also new and unique watercolor techniques, and the easy application of white highlighting onto the painting while wet and also after drying completely, and which is readily erasable using a damp cloth without causing a stain, leaving any residue or damage to the surface.

### FIELD

The embodiments presented relate to an erasable watermedia surface assembly, and in particular, to an erasable watermedia surface assembly and method of use which enables the complete erasures of any undesired tube-type or pan-type watercolor pigment along the surface area using a moist microfiber cloth material.

### BACKGROUND

Watercolor was invented in Europe by Renaissance artists in the late 15th century. Artists had to formulate, prepare and grind their own watercolor paint and tended to keep their recipes and methods secret. For the past 500 years, every artist working in this medium has faced three major problems in working with watercolor media and pigments: Setup, Consistency, and Erasability.

Setup: Regular watercolor paper is a porous surface similar to blotting paper and absorbs water and paint pigments. The thicker the paper, the more water is required to wet it thoroughly. Whether wet or dry, watercolor paper must be mounted on a rigid background such as plywood with tacks, tape, or clips in order to be stood up on an easel.

Consistency: Unless the water paper is wet thoroughly and pinned down or stretched onto the backing board prior to painting, the watercolor paper will warp or bulge upon painting on it, thus ruining the surface.

Watercolor artists have always had to deal with this problem of a lack of surface consistency, because they never knew how much or where the paper would warp or bulge. This inconsistency is caused by several factors, many of which are beyond the artist's control, such as temperature and humidity.

Erasability: Because tube-type and pan-type watercolor paint pigments are absorbed and diffused into the surface of any standard watercolor paper, such types of watercolor paint cannot be erased. Any mistake, even a minor one, can ruin a painting and it often must be discarded and started over. Any attempt to remove the unwanted pigment using different techniques such as “lifting” (wetting and blotting up unwanted pigments with an absorbent material) or scraping have been consistently unsuccessful, because any method of pulling out unwanted pigments leaves stains or discoloration. Repeating any process to remove the unwanted tube-type pigments results in excess rubbing which further damages the sensitive surface. There is no method currently available that completely removes all of the absorbent pigment. Consequently, once painted on, regular watercolor paper cannot be returned to its original pure white condition.

Various solutions that artists currently purchase claim to “erase”, but their results are usually due to the performing of some variant of the aforementioned “lifting” techniques which leaves stains on the watercolor. One such solution to this problem is described in various embodiments herein.

### SUMMARY OF THE INVENTION

Embodiments described herein provide for an erasable watermedia surface apparatus which allows a watercolor artist to begin painting with tube-type or pan-type watercolor paint or pigments without prior preparation of the painting surface. Further, the embodiments enable multiple and complete erasures of unwanted tube-type or pan-type watercolor pigments from said surface using a moist microfiber cloth. The apparatus is configured to be placed in a “stand-alone” position on an easel without the need for a traditional, rigid back support or creating the problematic “bulge” generated from traditional watercolor paper when water is applied.

The apparatus is comprised of a tempered hardboard backing support, water based contact cement, watercolor paper, and a matte urethane or polycrylic top coat finish which is evenly applied onto the board according to the methods provided.

In one aspect, a method of production includes laying down a sheet of 1/8 inch hardboard with the smooth side facing up on a smooth flat surface. The watercolor paper is laid down on a smooth flat surface of the same size as the hardboard with the textured side of the paper facing down. The watercolor paper is coated with a single coat of polyurethane and allowed to dry. Each surface that is facing up is coated with an even coat of waterbased contact cement and allowed to dry for one hour, allowing the cement to become tacky. The hardboard is lifted and turned over to be set down on the watercolor paper so that the two surfaces are fully aligned in two directions. The aligned surfaces are then lifted and turned so that the textured side of the watercolor paper is facing up. A roller is then used over the entire surface while downward pressure is applied to laminate the two surfaces into a single unit. A coat of polyurethane is applied to the surface of the textured side of the watercolor paper and allowed to dry according to instructions on the polyurethane container. This may vary with the ambient temperature and humidity of the environment. A second coat of polyurethane is then applied and allowed to dry completely. Preferentially, the surface is then inspected from an angle that allows the viewer to detect any imperfections in the finished product. The full sheet may now be sawed or laser cut to any preferred sizes.

Further features and advantages of the invention will appear more clearly on a reading of the following detail description of the preferred embodiment of the invention, which is given by way of non-limiting example only and with reference to the accompanying drawings.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates the erasable watermedia assembly positioned on an easel, according to an embodiment of the present invention;

FIG. 2 illustrates the components of the assembly, according to an embodiment of the present invention;

FIG. 3 illustrates the components of the assembly, according to an embodiment of the present invention;

FIG. 4 illustrates a perspective view of the roller and watermedia assembly, according to an embodiment of the present invention;

FIG. 5 illustrates a perspective view of the spray gun applying finish to the assembly, according to an embodiment of the present invention; and

FIG. 6 illustrates a flowchart of a method of preparing the erasable watermedia, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantages” provided by some embodiments, other embodiments may not include those same advantages, or may include different advantages. Any advantages described herein are not to be construed as limiting to any of the claims.

Before describing in detail exemplary embodiments, it is noted that the embodiments reside primarily in combinations of components related to the system. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

The assembly 100 is comprised of a rectangular shaped ⅛ inch tempered hardboard assembly 110. The ⅛ inch tempered hardboard 110 is relatively water-resistant and designed to resist warping and/or deterioration if not subjected to undue moisture. The assembly is also comprised of watercolor paper 120, water-based matte finish urethane or polycrylic 130 and water-based contact cement 140.

The present invention is a coated or primed substrate, similar to watercolor papers, suitable as a support or medium for watercolor painting using watercolor (water-based) paints, pens, markers and inks.

Watercolor techniques are distinguished from other painting techniques by their absorption of water and pigment into the watercolor paper.

Thus, the present invention's requirement of the artist to control the flow of water such that the water does not impede the watercolor paint's adherence to the surface, provides a range of “control” that allows the artist to create the desired amount of “flow” of the colors. Hydrophobic coatings are not suitable as they repel water resulting in undesirable characteristics of the medium.

Many embodiments of the watercolor paper 120 exist and may be utilized within the scope of the present invention.

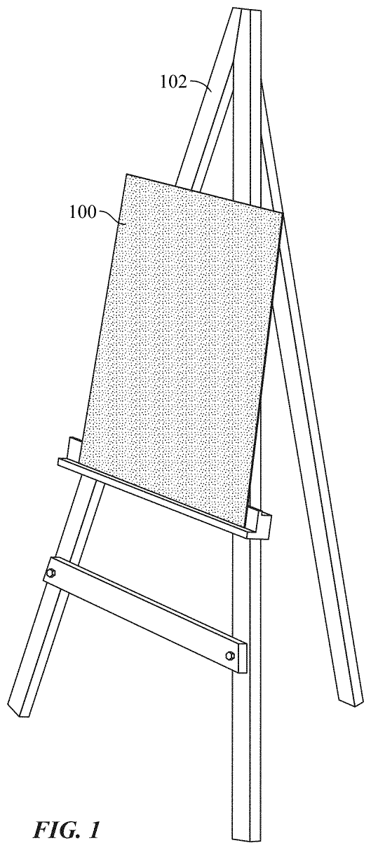

FIG. 1 illustrates the assembly 100 positioned on an easel 102. The assembly 1.00 is constructed with a sufficiently rigid hardboard 110 such that it may stand on the easel without the need for an auxiliary support structure as many watercolor paper assemblies require. This allows the artist to utilize the assembly on a number of surfaces and support structures not limited to an easel 102 without having to perform additional steps to ensure the assembly is supported by a rigid structure.

In an object of the present invention, the user may set up the assembly 100 and paint thereon. If a mistake occurs, or the user is in any way unsatisfied, the paint applied to the coated surface of the watercolor paper may be fully erased without requiring further stretching, pinning, taping, or clipping of an external sheet to the hardboard assembly 110.

In another object of the present invention, the light-weight tempered hardboard assembly 110 allows for the assembly to be utilized without an easel or other support structure. This is accomplished by utilizing a sufficiently rigid material for the hardboard assembly 110 such that it may stand on its own without flexing. This allows the entire assembly 100 to be positioned on an easel without the need for a backing as commonly used in the arts. In an embodiment, the assembly 100 is thin enough to be placed in most standard frames without modifying the frame.

The assembly provides an increased ease in the overall process of watercolor painting, thus making it more fun to engage in and more accessible to a wider audience, especially students, beginners, children, or the elderly who may just be learning to paint, or are physically incapable of complex tasks surrounding the art.

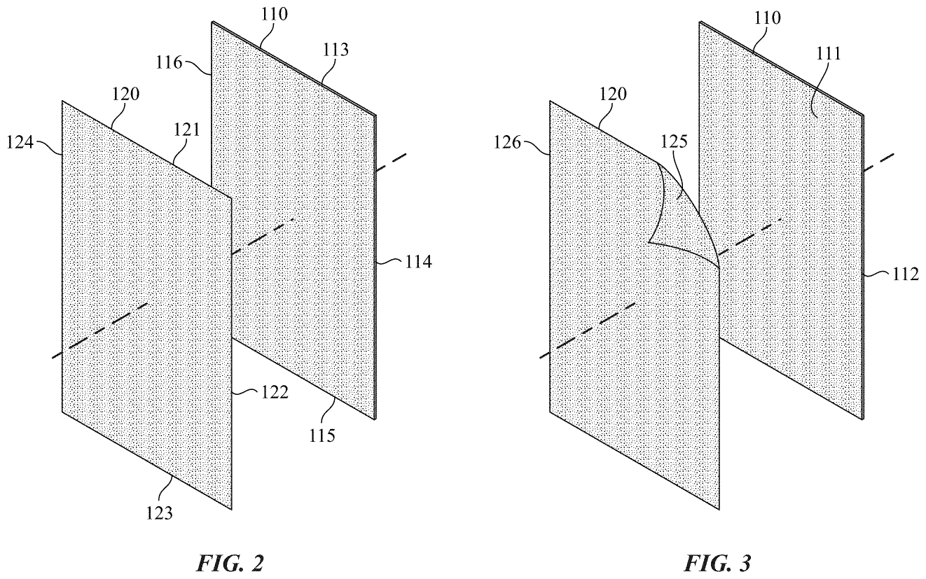

FIG. 2 illustrates an exploded view of the hardboard 110 and watercolor paper 120. The hardboard 110 is comprised of a first side 111 and second side 112 each having different texture and characteristics. For the purposes of definition in this assembly, these differences will be described as the “smooth side” 111 and the “rough side” 112. Edges (113, 114, 115, 116) define the perimeter of the hardboard 110. The watercolor paper 120 has edges 121, 122, 123, and 124.

FIG. 3 shows the watercolor paper 120 is the same surface on both sides, on the first side 125 and second side 126 of the watercolor paper. Either side 125 or 126 are textured as commonly utilized in the arts.

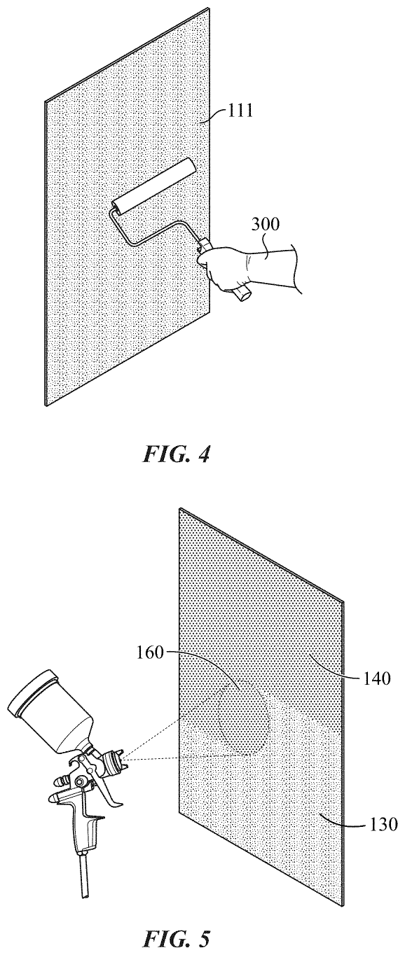

FIG. 4 illustrates the user rolling the adhered surfaces to ensure there are no imperfections. FIG. 5 illustrates the application of the polycrylic coating 130, followed by the application of the contact cement 160 utilizing a spray gun 300. The contact cement is applied to the smooth side of the board.

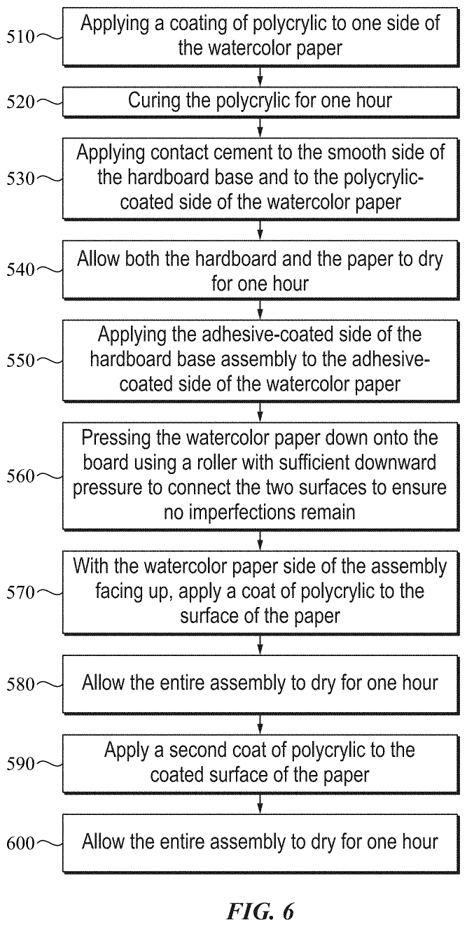

A preferred embodiment for the preparation of the assembly 100 is provided in FIG. 6. In step 500, the user procures a sheet of suitable hardboard, a suitable adhesive, and a suitable coating of appropriate sizes and quantities.

The hardboard and watercolor paper of similar or identical size are set down on a smooth surface next to one another and aligned for convenience. Preferentially, the hardboard is set down, having the smooth side facing up.

A single coating of polyurethane is required as a first coat to ensure that the contact cement is not absorbed into the paper. In step 510, a coating of polycrylic is applied to one side of the watercolor paper. In step 520, this polycrylic coating is allowed to cure for 1 hour.

Following the 1-hour dry time in step 530, the user must then apply a coating of contact cement adhesive to both the polycrylic side of the paper and the smooth side of the hardboard.

In step 540, the contact cement is allowed to cure and become tacky for 1 hour.

In step 550, the hardboard is set down atop the watercolor paper such that the edges line up lengthwise and the two surfaces align in each direction. The adhered assembly is lifted and turned over so that the watercolor paper is facing up.

In step 560. The user then presses and rolls the adhered hardboard and watercolor paper with a roller to remove any imperfections and ensure a tight connection therebetween. This procedure laminates the two components into a single cohesive unit.

In step 570, a finish coat of polycrylic is sprayed evenly onto the entire textured side surface of the watercolor paper and in step 580, the finish coat is allowed to cure for 1 hour.

In step 580, the entire assembly is allowed to dry for one hour. In step 590, a second coat of polycrylic is applied to the previously coated surface. In step 600, the entire assembly is dried for one hour.

Drying times may be amended with the use of dryers or other auxiliary curing and drying advices. These modifications will be made obvious to those skilled in the arts. If necessary, cutting of the materials may be accomplished by saws such as an automatic panel saw. Similar cutting implements may be used dependent on the size and intended use of the finished product.

Further, one skilled in the arts may appreciate that the present invention creates new and unique painting effects when used with both tube-type and pan-type watercolor paints.

The coated watercolor paper may be utilized with dry-brush techniques.

Further, the coated surface allows color to be removed to create effects such as clouds and other white objects.

Additionally, the user may remove by wetting the painted watercolor paper and wiping with a cloth while retaining the ability for paint to be reapplied. This step is not possible with uncoated paper substrates commonly utilized in the arts.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shah be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An erasable watermedia surface assembly, the assembly comprising:
a. a rectangular shaped hardboard base assembly configured to receive at least one coat of adhesive along a first surface and a sheet of watercolor paper configured to receive at least one layer of waterbased finish along a first surface and two separate coats of water based finish along the second surface.

2. The assembly of claim 1, wherein the two separate coats of water based finish accept watercolor paints, and wherein the two separate coats permit the removal of the watercolor paints.

3. The assembly of claim 2, wherein the two separate coats permit the selective removal of the watercolor paints.

4. The assembly of claim 2, wherein the two separate coats are clear matte urethane or polycrylic.

5. The assembly of claim 1, wherein the rectangular shaped hardboard is tempered with a defined width of ⅛ inch.

6. The assembly of claim 1, wherein the adhesive is a water based contact cement.

7. A method of creating an erasable watermedia surface assembly, the method comprising:
a. procuring, via a user, a hardboard base assembly;
b. procuring, via the user, a corresponding sheet of watercolor paper;
c. applying a first even coat of polycrylic onto a side of the watercolor paper;
d. curing the first even coat of the selected watercolor paper;
e. applying a first even coat of adhesive onto the side of the hardboard base assembly and onto the polycrylic-coated side of the watercolor paper;
f. curing the first even coat of adhesive;
g. applying a first even coat of adhesive onto the smooth side of the hardboard base assembly and onto the polycrylic-coated side of the watercolor paper;
h. curing the base assembly and the selected watercolor paper;
i. laminating the coated side of the base assembly onto the coated side of the watercolor paper;
j. rolling the watercolor paper onto the assembly;
k. applying two coats of the waterbased matte finish

8. The method of claim 7, wherein the assembly receives and selectively permits removal of watercolor paints.

9. The method of claim 7, wherein the base assembly is tempered hardwood.

10. The method of claim 7, wherein the second coat of matte urethane or polycrylic finish cures for one hour.

11. The method of claim 10, wherein the finish coat of matte urethane or polycrylic finish cures at room temperature for eight hours.

12. The method of claim 7, wherein the assembly is sufficiently rigid to be mountable on an easel or a flat surface.

13. The method of claim 7, wherein the assembly is mountable to a standard frame without modifying the frame.

14. The method of claim 7, wherein the adhesive is a water based contact cement.

15. An erasable watermedia surface system comprising:
a. a hardboard base having a first side and a second side;
b. a watercolor paper having a first side and a second side;
c. a user performing the steps of;
i. applying, utilizing a spray gun, polycrylic to the first side of the watercolor paper;
ii. drying the polycrylic for one hour;
iii. applying, utilizing a spray gun, a contact cement adhesive to a side of the hardboard base and the polycrylic side of the watercolor paper;
iv. drying the adhesive for one hour;
v. adhering the watercolor color paper and the hardboard base to form an assembly;
vi. turning the assembly to orient the watercolor paper vertically;
vii. applying a coat of polycrilic to the watercolor paper; and
viii. applying a second finish coat of polycrylic to the watercolor paper; and
ix. curing for at least eight hours.

16. The system of claim 15, wherein the adhesive is a water based contact cement.

17. The system of claim 15, wherein the finish is matte urethane or polycrylic.

18. The system of claim 15, wherein the assembly retains a water based media thereon.

19. The system of claim 18, wherein the finish permits the user to remove waterbased media applied thereon.

20. The system of claim 19, wherein the user is not required to use a chemical solvent to remove the waterbased media.
